(19) United States
(12) Patent Application Publication
(10) Pub. No.: US 2012/0057729 A1
(43) Pub. Date: Mar. 8, 2012

(54) MEMS MICROPHONE PACKAGE

(76) Inventor: Lutz RAUSCHER, Reutlingen (DE)

(21) Appl. No.: 13/199,079

(22) Filed: Aug. 17, 2011

(30) Foreign Application Priority Data
Sep. 8, 2010 (DE) 10 2010 040 370.9

(51) Int. Cl. H04R 1/00

(52) U.S. Cl. 381/174

(57) ABSTRACT

A microelectromechanical system microphone package has at least one sensitive diaphragm provided in the front side of a microphone component. The microphone component and a cap wafer are connected to one another with their front sides facing one another. The cap wafer functions as an intermediate wafer for installing the microelectromechanical system microphone package. The cap wafer is provided with feedthroughs so that the microphone component is electrically contactable via the cap wafer.

### BACKGROUND OF THE INVENTION

1. Field of the Invention

The present invention relates to microelectromechanical system (MEMS) microphone packages which include at least one micromechanical microphone component having at least one acoustically sensitive diaphragm provided in the front side of the component, a cap wafer for protecting the diaphragm, and means for electrically contacting the microphone component.

2. Description of the Related Art

Integrated circuits as well as MEMS components are provided with a package, i.e., a housing, for further use, which is referred to as a “first-level package” or also only as a “package.” This package is used for mechanically protecting the chip, and simplifies installation of the chip on a printed circuit board, for example. In addition, the package must allow simple electrical contacting of the chip for the installation, for example by soldering. A sound entry opening must also be provided in the package of a microphone component.

MEMS microphone components having packages based on printed circuit boards as well as MEMS microphone components having ceramic housings are known in practice. Both packaging concepts are associated with relatively high manufacturing complexity. In addition, the known packages are relatively large in comparison to the size of the chip.

### BRIEF SUMMARY OF THE INVENTION

According to the present invention, a wafer level-based packaging concept for MEMS microphone components of the type mentioned at the outset is proposed which allows particularly simple and cost-effective packaging of MEMS microphone components, with very small space requirements.

According to a first variant of the packaging concept according to the present invention, the structured back side of the cap wafer is connected to the front side of the microphone component. In this case, sound is introduced via at least one sound opening in the back side of the component. In this first variant, the microphone component is provided with feedthroughs so that the microphone component is electrically contactable from its back side.

In a second variant of the packaging concept according to the present invention, the microphone component and the cap wafer are connected to one another with their front sides facing one another (face to face). In this case the cap wafer functions as an intermediate wafer for installing the MEMS microphone package. Accordingly, in this second variant the cap wafer is provided with feedthroughs so that the microphone component is electrically contactable via the cap wafer.

Both package variants according to the present invention are based on the concept of implementing the package of a MEMS microphone component in the form of a wafer stack. The diaphragm and the electrical circuit of the micromechanical microphone chip are protected by a cap wafer. The electrical connections of the microphone chip are guided in the form of feedthroughs to the installation side of the wafer stack, so that the package may be installed and contacted using standard methods, for example as a so-called flip-chip. If the back side of the microphone chip is used as a mounting surface, as in the first implementation variant of the packaging concept according to the present invention, the feedthroughs connect the circuit elements on the active front side of the chip to the back side of the chip. However, if the installation is carried out via the cap wafer, as in the second implementation variant of the packaging concept according to the present invention, the feedthroughs extend through the cap wafer and connect the circuit elements on the front side of the chip to the installation side of the cap wafer. In both variants, the packages having the external electrical connections, together with the micromechanical and circuitry functionality of the microphone chip, are placed in the wafer composite, and are separated with the microphone chips in one step, so that there is no longer a need for a further packaging step. This extensive parallelization of chip manufacturing and packaging is not only extremely efficient with regard to the manufacturing process and the manufacturing costs, but also allows the component size to be reduced to a minimum. Accordingly, packages according to the present invention require much less printed circuit board space than the known MEMS microphone packages. The packages according to the present invention also have a lower installation height than the known MEMS microphone packages. This miniaturization with regard to surface area as well as height opens up numerous options for developing novel and improved end products having a microphone function.

As previously mentioned, there are various options for implementing the packaging concept according to the present invention, depending on whether the cap wafer is situated on the active front side or on the back side of the microphone chip, and depending on whether the sound is to be delivered from the installation side or from the top side of the microphone housing.

A particularly large number of configuration options results when the cap wafer is also used as an intermediate wafer for installing the microphone package. In this case, the microphone chip and the cap wafer are connected to one another face to face, and the microphone chip is externally contacted via feedthroughs in the cap wafer.

If the sound is to act on the front side of the diaphragm, at least one sound opening must be provided in the cap wafer. In one advantageous embodiment of this variant, an acoustically inactive grid-like diaphragm structure is provided in the front side of the cap wafer, and sound is introduced via the openings in this diaphragm structure. With the aid of the grid-like diaphragm structure, the penetration of particles into the microphone structure may be effectively prevented without appreciable acoustic losses.

If the diaphragm is accessible from the back side of the chip, the back-side volume of the diaphragm should be defined by at least one additional layer on the back side of the microphone component. The back-side layer is designed to provide the package with the most robust surface possible, and in particular to protect the diaphragm from harmful environmental influences. In addition, the back-side layer is to be applied and machined using standard processes in semiconductor technology. In order to meet these requirements, the back-side layer may be implemented, for example, in the form of a film or back-side wafer made of plastic, glass, or silicon. In one particularly advantageous specific embodiment of the present invention, a structured back-side wafer made of silicon or another semiconductor material, for example, is used as the back-side layer. The acoustic properties of the microphone package may be influenced in a targeted manner via the structure of the back-side wafer. Thus, for example, the back-side volume of the diaphragm may be dimensioned in a defined manner by a more or less large recess in the back-side wafer. Furthermore, the acoustic properties may be influenced by vents in the back-side wafer which communicate with the back-side volume of the diaphragm.

In another specific embodiment of a MEMS microphone package according to the present invention having a face-to-face connection between the microphone chip and the cap wafer, the sound is introduced on the back side of the diaphragm. For this purpose, at least one sound opening must be provided in the back side of the microphone component. In this case, a recess in the cap wafer is used as a back side volume for the diaphragm, the size of this recess influencing the acoustic properties of the microphone system. For this purpose, vents may also be provided in the cap wafer, which vents communicate with the back-side volume of the diaphragm. With regard to the most compact, robust design of the microphone package possible and as protection from the penetration of dirt particles, the back side of the microphone component may be provided with an additional layer which is acoustically permeable at least in the region of the sound opening. A fine-meshed gauze, a structured film, or a structured foil may be used for this purpose.

For all of the embodiment variants of the packaging concept according to the present invention which are stated and described above, it has proven to be advantageous when the cap wafer and optionally the additional layer on the back side of the microphone component are made of an electrically conductive material, or are at least coated with an electrically conductive material, in order to shield the microphone structure from electromagnetic disturbances.

The MEMS microphone packages according to the present invention may be mounted on a printed circuit board, optionally via a sound opening in the printed circuit board, using standard processes, and thus provide the option for implementing in a very simple manner packages which may be adapted to almost any needs of the particular application. These also include applications in which multiple microphones are combined in a device having an additional functionality. For this purpose, the packaging concept according to the present invention requires neither a special design nor special manufacturing processes for the microphone chip, nor special packaging and installation techniques.

### BRIEF DESCRIPTION OF THE DRAWINGS

FIG. 1 shows a schematic sectional view of a MEMS microphone package 10 according to a first variant of the packaging concept according to the present invention.

FIGS. 2a and 2b illustrate the production of the MEMS microphone package 10 shown in FIG. 1 in the wafer composite.

FIGS. 3a and 3b each show a schematic sectional view of a MEMS microphone package 20 and 30, respectively, according to a second variant of the packaging concept according to the present invention, with sound introduction via the cap wafer.

FIG. 4 shows a schematic sectional view of another MEMS microphone package 40 according to the second variant of the packaging concept according to the present invention, with sound introduction via the back side of the microphone component.

FIGS. 5a and 5b show schematic sectional views of packages according to the present invention with a printed circuit board installed.

FIGS. 6a through 6c show three examples of the installation of packages according to the present invention.

### DETAILED DESCRIPTION OF THE INVENTION

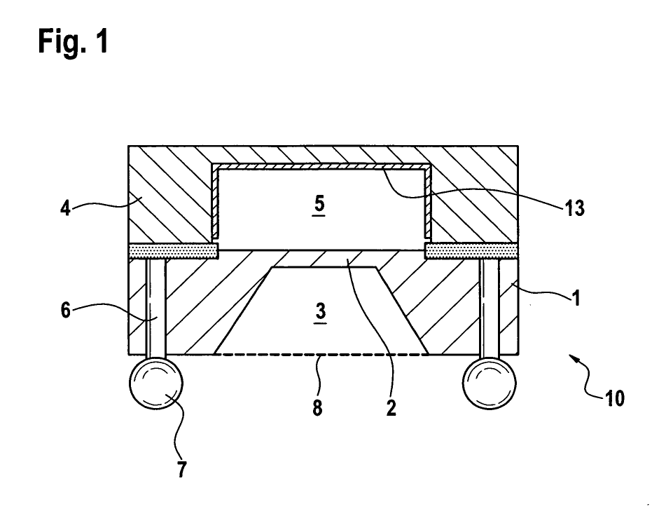

MEMS microphone package 10 illustrated in FIG. 1 is implemented in the form of a wafer-level package (WLP), i.e., in the form of a wafer stack. The MEMS microphone package includes a microphone component 1, which is also referred to below as a microphone chip 1. An acoustically sensitive diaphragm 2 is provided in the front side of microphone chip 1, and bridges a cavern 3 in the back side of the chip. In the exemplary embodiment described here, diaphragm 2 is acted on by sound via cavern 3, which functions as a sound opening. Circuit elements are also usually present on the front side of a microphone chip; however, for the sake of clarity they are not illustrated, and with regard to the circuit elements only the electrical contacts for the signal transmission are taken into account here.

Package 10 also includes a cap wafer 4, which in the present case is situated on the front side of microphone chip 1, and which accordingly protects the front side of microphone chip 1 together with the circuit components and diaphragm 2 from environmental influences. A recess 5 is provided in the back side of cap wafer 4, and is situated above diaphragm 2 and thus functions as a back-side volume for microphone diaphragm 2. Cap wafer 4 may be, for example, a silicon wafer which is structured on the back side. In the exemplary embodiment illustrated here, cap wafer 4 has been provided with a conductive layer 13 in the region of recess 5 in order to shield the microphone circuit from electromagnetic disturbances.

Package 10 is placed at its point of use, i.e., mounted on a printed circuit board, for example, via the back side of microphone chip 1. For this reason, the electrical connections for the circuit components situated on the front side of the chip are guided to the back side of the chip with the aid of feedthroughs 6 in microphone chip 1. In the exemplary embodiment illustrated here, the back-side contacts are provided with solder balls 7 for the subsequent installation on a printed circuit board. In addition, sound opening 3 has been covered with an acoustically permeable layer 8, made of plastic gauze, for example, in order to prevent dirt particles or liquids from penetrating into the sound opening of the microphone structure.

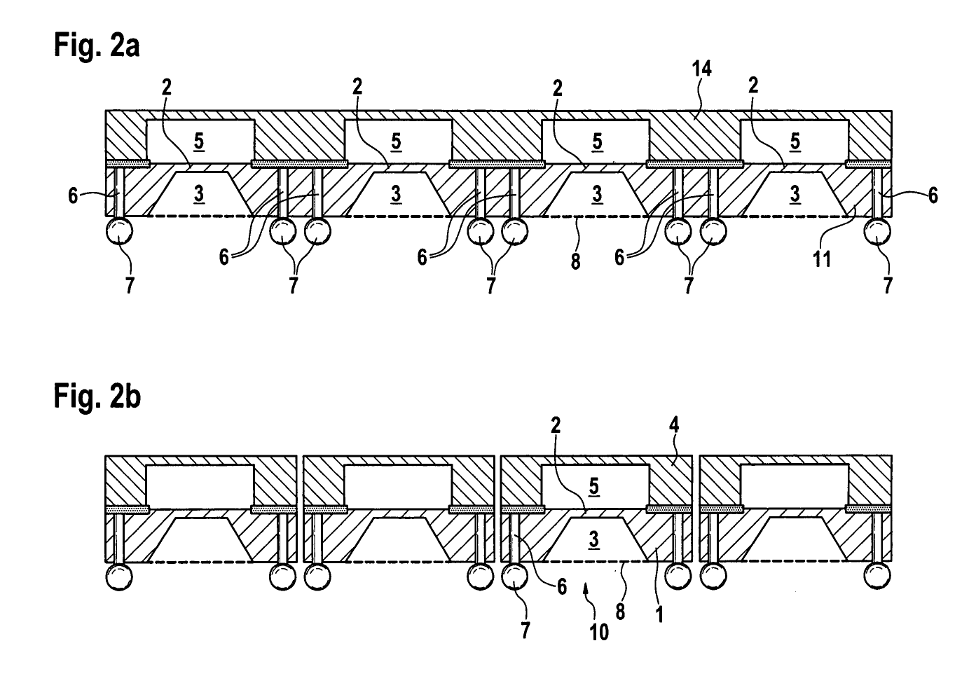

FIGS. 2a and 2b show that microphone package 10 illustrated in FIG. 1 is placed in the wafer composite.

FIG. 2a illustrates a first processed and back side-structured wafer 11 in which the functionality of multiple microphone chips has been implemented. Diaphragms 2 and feedthroughs 6 together with solder balls 7 are apparent here. The contact holes of feedthroughs 6 are advantageously produced in one production step together with the caverns, i.e., sound openings 3. The back side of wafer 11 structured in this way has also been subsequently provided with an acoustically permeable gauze layer 8. A cap wafer 14 has been processed and structured on the back side, independently from microphone chip wafer 11. Recesses 5 have been produced whose opening size is adjusted to the size of diaphragms 2, and which are also situated in the same grid as diaphragms 2.

FIG. 2a shows the two wafers 11 and 14 after they have been aligned one on top of the other and connected to one another, so that one recess 5 is positioned above each diaphragm 2, forming the back-side volume for this diaphragm 2. The connection between the two wafers 11 and 14 must ensure that an air reservoir which meets the acoustic requirements is present in the back-side volume. The connection between wafers 11 and 14 may be glued, soldered, glazed, or alloyed.

Only after the two wafers 11 and 14 have been connected to one another is the separation carried out, resulting in individual MEMS microphone packages 10. This is illustrated in FIG. 2b. Known methods such as sawing, laser beam cutting, or water jet cutting may be used for the separation.

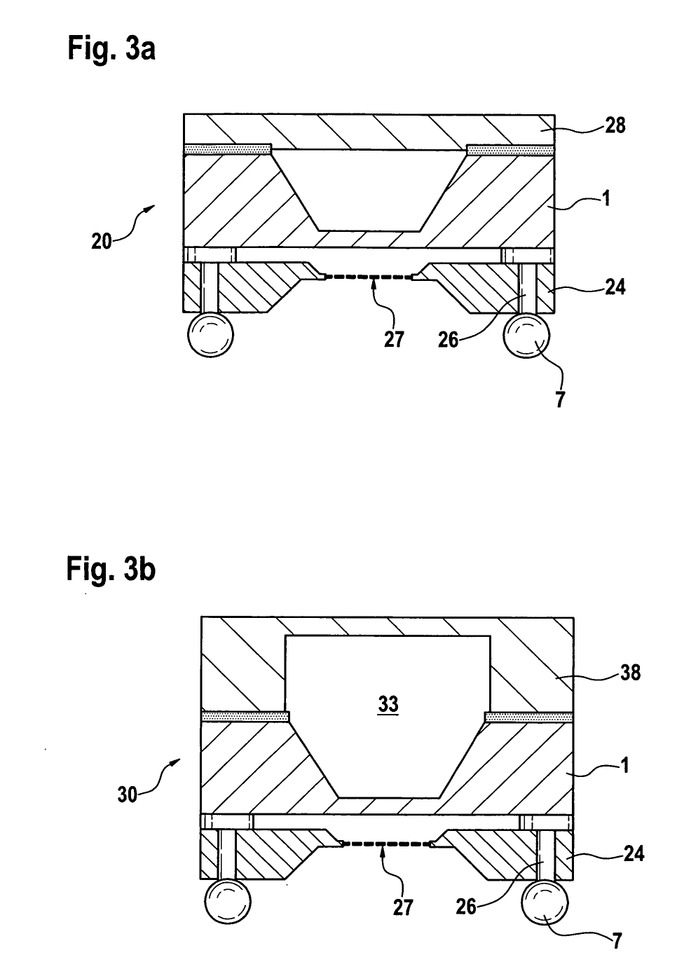

MEMS microphone package 20 illustrated in FIG. 3a is also implemented in the form of a wafer-level package (WLP), and includes a microphone component 1 and a cap wafer 24, in the front side of microphone component 1 an acoustically sensitive diaphragm 2 being provided above a cavern 3 which is open at the back side. In the variant of the packaging concept according to the present invention illustrated here, cap wafer 24 is connected to microphone chip 1 face to face, i.e., with their front sides facing one another. The same as for MEMS microphone package 10, this connection may be glued, soldered, glazed, or alloyed. In any event, the connection should be provided in such a way that the microphone structure is protected from penetration by liquids and particles, and that an electrical contact exists between the circuit components on the front side of the chip and cap wafer 24, the connection extending annularly, for example, around the diaphragm region. Since package 20 is placed and mounted at its point of use via cap wafer 24, cap wafer 24 is also referred to as an intermediate wafer. Feedthroughs 26 are provided in cap wafer 24, via which the circuit components situated on the front side of microphone chip 1 are electrically contacted at the installation site. In the present case, the electrical contacts of package 20 have been provided with solder balls 7 for subsequent installation on a printed circuit board.

In the case of package 20, diaphragm 2 is acted on by sound via the openings in an acoustically permeable diaphragm structure 27 in cap wafer 24. This diaphragm structure 27 has been exposed in the course of a back side structuring of cap wafer 24 in which the contact holes of feedthroughs 26 have also been produced. The diaphragm structure protects microphone structure 27 from mechanical influences and soiling. In addition, cap wafer 24 may be provided with metal plating and/or with conductive structures in order to shield the component from electromagnetic disturbances.

In the present case, the back-side volume of diaphragm 2 is closed off by an additional layer 28, which also provides package 20 with a robust surface for further use. This additional layer or ply may be a suitable film or a plastic wafer 8, for example. The same as for cap wafer 24, back-side layer 28 may also be made of a conductive material or may be provided with a conductive coating, which improves the electromagnetic shielding of package 20.

The above-described sandwich design of MEMS microphone package 20 protects the microphone structure particularly well from penetration by dirt particles, liquids, and other harmful environmental influences. Exactly the same as for package 10, the sandwich design may be applied at the wafer level and produced using standard processes in chip manufacturing.

MEMS microphone package 30 illustrated in FIG. 3b and MEMS microphone package 20 illustrated in FIG. 3a differ only with respect to rear layer 38 and 28, respectively. Namely, for package 30, back-side volume 33 of diaphragm 2 is closed off by a structured wafer 38. This structured wafer is preferably a silicon wafer. However, other materials such as glass or plastic, for example, may be used. The acoustic properties of the microphone component may be modified in a targeted manner by the structuring of back-side wafer 38. In the present case, a back-side volume 33 which is larger than the variant illustrated in FIG. 3a has been produced in order to improve the acoustic quality of the component. In addition, the acoustic properties may be varied by providing back-side wafer 38 with vents which communicate with back-side volume 33 of diaphragm 2.

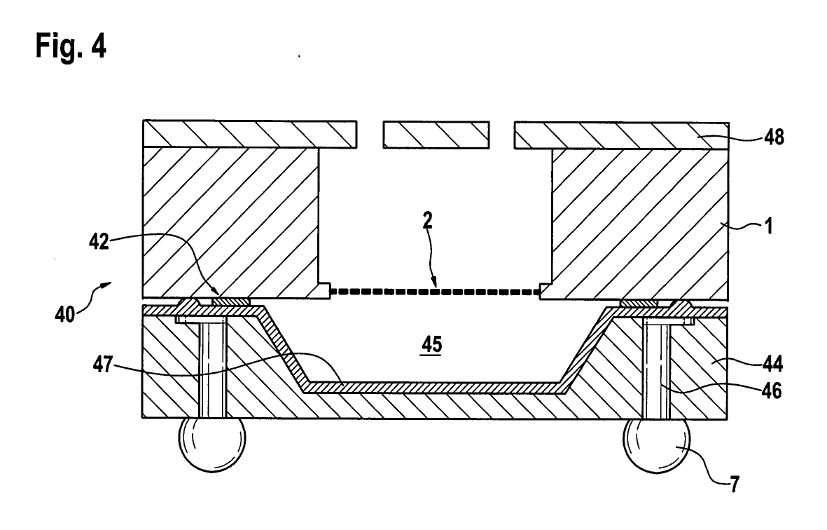

The same as for MEMS microphone packages 20 and 30, microphone chip 1 and cap wafer 44 of MEMS microphone package 40 illustrated in FIG. 4 are connected to one another face to face. Since package 40 is also placed and mounted at its point of use via cap wafer 44, feedthroughs 46 are provided in cap wafer 44 via which the circuit components on the front side of microphone chip 1 are electrically contacted. For this purpose, a contact region 42 which extends annularly around the diaphragm region is provided in the connection between microphone chip 1 and cap wafer 44.

However, in the present case the sound introduction is provided not via cap wafer 44, but, rather, is provided on the side opposite from the installation side. Accordingly, diaphragm 2 is acted on by sound via sound opening 3 in the back side of microphone chip 1. In the present case, the required back-side volume for diaphragm 2 has been produced by an appropriate structuring of cap wafer 44 in the form of a recess 45. Within the scope of this structuring, vents which communicate with back-side volume 45 as well as the contact holes for feedthroughs 46 may also be produced. In addition, the structured front side of cap wafer 44 has been provided with an electrically conductive coating 47 for electromagnetic shielding. In this variant as well, cap wafer 44 protects microphone diaphragm 2 from mechanical external influences, and, with an appropriate coating, also protects it from external electromagnetic influences.

In the exemplary embodiment illustrated here, an acoustically permeable cover 48 is also located above back-side sound opening 3, thus minimizing penetration of light and contaminants into the microphone structure. This cover may be implemented in the form of a fine-meshed gauze or structured foil, for example.

All MEMS microphone packages 10, 20, 30, and 40 described above may be placed in the wafer composite and mounted on a printed circuit board after the separation. This printed circuit board may then be sawed to complete the packaging of the individual packages. In any event, the printed circuit board provides the particular package with additional mechanical protection. The printed circuit board may also protect from light penetration and electromagnetic disturbances.

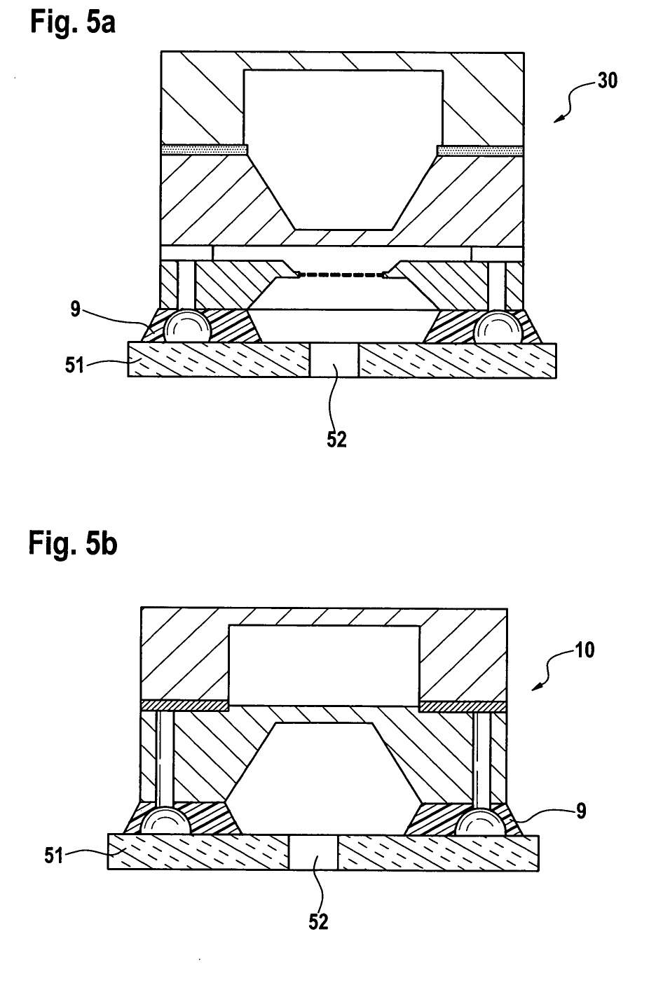

FIG. 5a illustrates package 30 with a printed circuit board installed, and FIG. 5b illustrates package 10 with a printed circuit board installed. In both cases, packages 30 and 10 are connected to printed circuit board 51 in a hermetically sealed manner via solder balls 7 and with the aid of underfill material 9. In each case, sound application takes place via a sound opening 52 in printed circuit board 51.

FIGS. 5a and 5b show that the MEMS microphone packages according to the present invention may be easily adapted to application-related special requirements with the aid of a printed circuit board assembly.

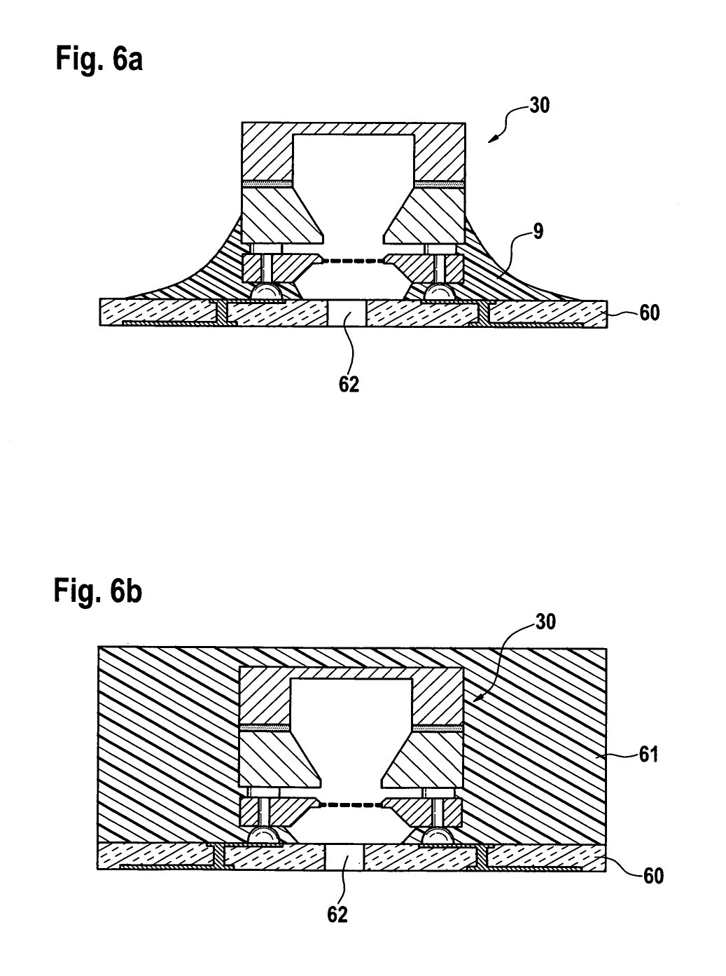

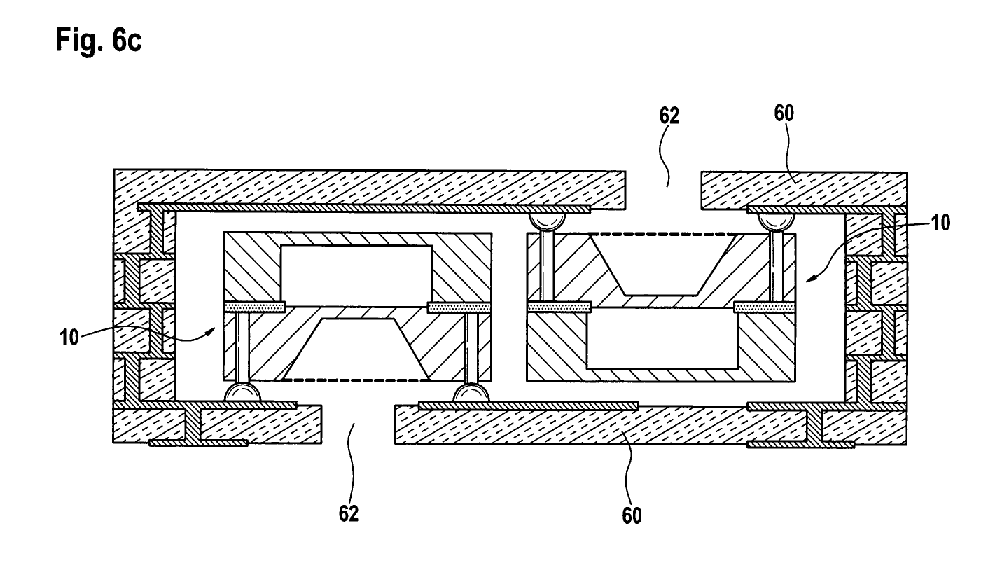

FIGS. 6a through 6c illustrate three examples of the further use of the MEMS microphone packages according to the present invention as a package in package (PiP) configuration, which likewise allows a simple and cost-effective adaptation to particular installation situations.

Thus, the above-described packages according to the present invention may be easily mounted in a conventional manner on a ceramic support or a printed circuit board 60, as illustrated in FIG. 6a using the example of package 30. FIG. 6b shows the same design completely embedded in molding compound 61. However, the packaging technique according to the present invention also allows the implementation of multifunctional components in which multiple microphone components and optionally also sensor elements for acceleration or pressure are combined, for example microphone arrays, noise canceling, etc. As an example, a printed circuit board-based package having two microphone packages 10 is illustrated in FIG. 6c. In this case, the two microphone packages 10 are integrated into a module having novel functionality by arranging the microphone packages in a sandwich-like manner between two printed circuit boards 60 and installing each over a sound opening 62.

What is claimed is:

1. A microelectromechanical system microphone package, comprising:
a microphone component having at least one acoustically sensitive diaphragm provided in the front side of the microphone component;
a cap wafer configured to protect the diaphragm; and
means for electrically contacting the microphone component;
wherein i) a structured back side of the cap wafer is connected to the front side of the microphone component, ii) sound is introduced via at least one sound opening in the back side of the microphone component, and iii) the microphone component is provided with feedthroughs configured to enable the microphone component to be electrically contacted from the back side of the microphone component.

2. A microelectromechanical system microphone package, comprising:
a microphone component having at least one acoustically sensitive diaphragm provided in the front side of the microphone component;
a cap wafer configured to protect the diaphragm; and
means for electrically contacting the microphone component;
wherein i) the microphone component and the cap wafer are connected to one another with front sides of the microphone component and the cap wafer facing one another, ii) the cap wafer functions as an intermediate wafer for installing the microelectromechanical system microphone packages, and iii) the cap wafer is provided with feedthroughs configured to enable the microphone component to be electrically contacted via the cap wafer.

3. The microelectromechanical system microphone package as recited in claim 2, wherein an acoustically inactive grid-like diaphragm structure is provided in the front side of the cap wafer, and sound is introduced via the openings in the grid-like diaphragm structure.

4. The microelectromechanical system microphone package as recited in claim 2, wherein the back side of the microphone component is connected to an additional layer which is implemented in the form of one of a film or a back-side wafer, the additional layer being made of one of plastic, glass, or a semiconductor material.

5. The microelectromechanical system microphone package as recited in claim 4, wherein the back-side volume of the diaphragm is defined by the additional layer on the back side of the microphone component.

6. The microelectromechanical system microphone package as recited in claim 5, wherein the additional layer on the back side of the microphone component is formed by a structured back-side wafer having at least one of i) a recess for enlarging the back-side volume of the diaphragm, and ii) a vent which communicates with the back-side volume of the diaphragm.

7. The microelectromechanical system microphone package as recited in claim 2, wherein sound is introduced via at least one sound opening in the back side of the microphone component, and a recess in the cap wafer forms the back-side volume for the diaphragm.

8. The microelectromechanical system microphone package as recited in claim 7, wherein the cap wafer has vents which communicate with the back-side volume of the diaphragm.

9. The microelectromechanical system microphone package as recited in claim 7, wherein the back side of the microphone component is protected by at least one additional layer which is acoustically permeable at least in the region of the sound opening.

10. The microelectromechanical system microphone package as recited in claim 9, wherein the additional layer on the back side of the microphone component is implemented in the form of one of a fine-meshed gauze, a structured film, or a structured foil.

11. The microelectromechanical system microphone package as recited in claim 9, wherein the cap wafer and the additional layer on the back side of the microphone component are at least coated with an electrically conductive material.

12. The microelectromechanical system microphone package as recited in claim 11, wherein the microphone package is installed on a printed circuit board over a sound opening in the printed circuit board, and wherein microphone package is contacted via the feedthroughs.

13. The microelectromechanical system microphone package as recited in claim 11, wherein the microphone package is used as a part of a package-in-package (PiP) configuration.
